(19) United States
(12) Patent Application Publication
(10) Pub. No.: US 2025/0131933 A1
(43) Pub. Date: Apr. 24, 2025

(54) PACKET LOSS CONCEALMENT IN AN AUDIO DECODER

(71) Applicant: Cisco Technology, Inc., San Jose, CA (US)

(72) Inventors: Amir Salah Abdelsamie Abdelwahed, Edinburgh (GB); Yusuf Ziya Isik, Edinburgh (GB); Xuehong Mao, San Jose, CA (US); Samir Ouelha, Suresnes (FR); Samer Lutfi Hijazi, San Jose, CA (US)

(21) Appl. No.: 18/539,804

(22) Filed: Dec. 14, 2023

Related U.S. Application Data
(60) Provisional application No. 63/591,227, filed on Oct. 18, 2023.

(51) Int. Cl. G10L 19/08; G10L 19/00

(52) U.S. Cl. CPC G10L 19/08; G10L 2019/0012; G10L 2019/0013

(57) ABSTRACT

A method of performing packet loss concealment in a neural audio encoder/decoder (codec) system. The method includes receiving an indication of a lost audio packet at a receive side of a neural network audio codec system that includes an audio encoder and an audio decoder, wherein the lost audio packet comprises an index of a codeword that is representative of a portion of speech audio presented to the audio encoder, predicting the index of the codeword in the lost packet to obtain a predicted index, deriving a predicted embedding vector from the predicted index, and decoding, by the audio decoder, the embedding vector to generate an audio output.

### PRIORITY CLAIM

This application claims the benefit of U.S. Provisional Patent Application No. 63/591,227, filed Oct. 18, 2023, which is hereby incorporated by reference in its entirety.

### TECHNICAL FIELD

The present disclosure relates to audio processing, and more particularly to language model-based packet loss concealment in an audio decoder.

### BACKGROUND

Audio coding/decoding (codec) systems play a role in real-time communication technologies, aiming to preserve audio content quality and intelligibility while minimizing bit consumption. Network resilience, including the ability to handle packet loss, is another criterion for designing codecs for real-time communications. The integration of machine learning techniques and the development of end-to-end neural codecs have driven advancements in bitrate reduction and audio quality.

In addition to encoding the audio signal, there is a role for audio enhancement in extensively utilized real-time communication solutions. Deep neural networks have shown promising results in addressing the challenges of audio enhancement in noisy and reverberant environments.

### BRIEF DESCRIPTION OF THE DRAWINGS

FIG. 1 is a system block diagram of a neural network audio codec system according to an example embodiment.

FIG. 2 is a diagram depicting end-to-end training of a neural network audio codec system according to an example embodiment.

FIG. 3 depicts a block diagram of the receive side of the neural audio codec system including a nano Language Model (LM) Predictor configured for packet loss concealment according to an example embodiment.

FIG. 4 illustrates one approach for training the nano LM Predictor with classification loss according to example embodiment.

FIG. 5 illustrates another approach for training the nano LM Predictor with distance-based regression loss according to example embodiment.

FIG. 6 is a flowchart illustrating a series of operations executed by the nano LM Predictor and logic thereof according to an example embodiment.

FIG. 7 is a block diagram of a computing device that may be configured to execute logic for the nano LM Predictor and perform the techniques described herein according to an example embodiment.

### DETAILED DESCRIPTION

### Overview

A method of performing packet loss concealment in a neural audio encoder/decoder (codec) system. The method may include receiving an indication of a lost audio packet at a receive side of a neural network audio codec system that includes an audio encoder and an audio decoder, wherein the lost audio packet comprises an index of a codeword representative that is representative of a portion of speech audio presented to the audio encoder, predicting the index of the codeword in the lost packet to obtain a predicted index, deriving a predicted embedding vector from the predicted index, and decoding, by the audio decoder, the embedding vector to generate an audio output.

In another embodiment, a method may include receiving a sequence of audio packets representing speech audio, each audio packet including an index of a codeword that is representative of a portion of the speech audio, predicting an index of a codeword for a current audio packet based on one or more previous audio packets in the sequence, deriving a predicted embedding vector from the predicted index, and decoding the predicted embedding vector to generate audio output.

In still another embodiment, a device is provided. The device includes an interface configured to enable network communications, a memory, and one or more processors coupled to the interface and the memory, and configured to receive an indication of a lost audio packet at a receive side of a neural network audio codec system that includes an audio encoder and an audio decoder, wherein the lost audio packet comprises an index of a codeword representative that is representative of a portion of speech audio presented to the audio encoder, predict the index of the codeword in the lost packet to obtain a predicted index, derive a predicted embedding vector from the predicted index, and decode, by the audio decoder, the embedding vector to generate an audio output.

### Example Embodiments

### Neural Network Audio Codec System

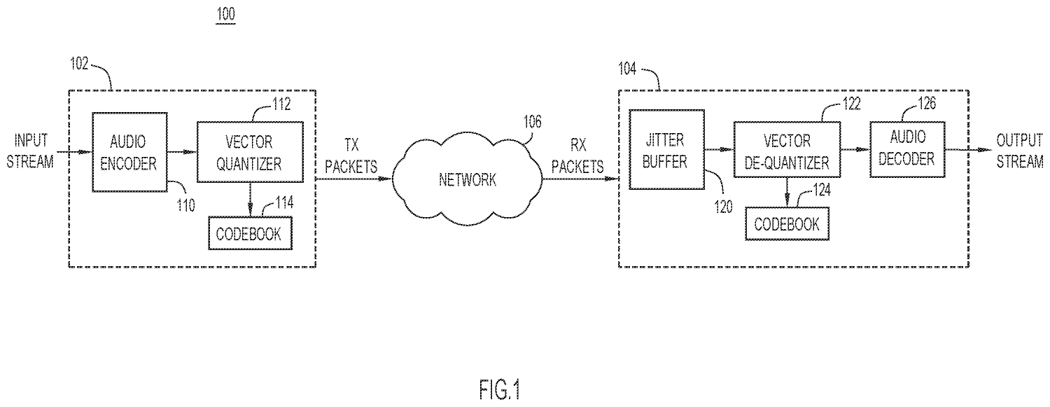

Reference is first made to FIG. 1. FIG. 1 shows a block diagram of a neural audio encoder/decoder (codec) system 100. The neural audio codec system 100 includes a transmit side 102 and a receive side 104, which may be separate at devices that are in communication with each other via network 106. The network 106 may be a combination of (wired or wireless) local area networks, (wired or wireless) wide area networks, public switched telephone network (PSTN), etc.

At the transmit side 102, there is an audio encoder 110 and a vector quantizer 112. The vector quantizer uses a codebook 114. The audio encoder 110 receives an input audio stream (that includes speech as well as artifacts and impairments). The audio encoder 110 may use a deep neural network that takes the input audio stream and transforms it, frame-by-frame, into high-dimensional embedding vectors that keep all the important information and optionally removes unwanted information such as the artifacts and impairments. The duration of the frames may be 10-20 millisecond (ms), for example. The audio encoder 110 may be composed of convolutional, recurrent, attentional, pooling, or fully connected neural layers as well as any suitable nonlinearities and normalizations. The vector quantizer 112 quantizes the high-dimensional vectors at the output of the audio encoder 110, called embedding vectors herein. For example, the vector quantizer 112 may use techniques such as Residual Vector Quantization by selecting a set of codewords (from the codebook 114) from each layer to optimize a criterion reducing quantization error at the output stream on receive side. The indices of the selected codewords for each frame are put into transmit (TX) packets and sent to the receive side 104, or they may be stored for later retrieval and use. It some implementations, the audio encoder 110 may generate the quantized vectors (indices) directly without the need for a separate vector quantizer 112.

The receive side 104 obtains receive (RX) packets from the network 106. At the receive side 104, there are a jitter buffer 120, vector de-quantizer 122, codebook 124 and an audio decoder 126. The jitter buffer 120 keeps track of the incoming packets, putting them in order and deciding when to process and play a packet. The jitter buffer 120 may also be used to detect packet loss. The vector de-quantizer 122 de-quantizes received codeword indices and using the codebook 124, outputs recovered embedding vectors. The audio decoder 126 decodes the embedding vectors to produce an output audio stream.

Though not specifically shown in FIG. 1 there may be an encoder, vector quantizer, vector de-quantizer and decoder at each device to enable two-way communications.

Techniques are provided for a generative artificial intelligence (AI) architecture built on the neural audio codec system 100 shown in FIG. 1. At the core of this architecture is a compact speech vector that has great potential for a wide range of speech AI and other applications. The proposed unified architecture offers a versatile solution applicable to various content, including but not limited to: speech enhancement (such as background noise removal, de-reverberation, speech super-resolution, bandwidth extension, gain control, and beamforming), packet loss concealment (with or without forward error correction (FEC)), acoustic speech recognition (ASR), speech synthesis, also referred to as text-to-speech (TTS), voice cloning and morphing, speech-to-speech translation (S2ST), and audio-driven large language model (AdLLR).

### Training the Neural Network Audio Codec System

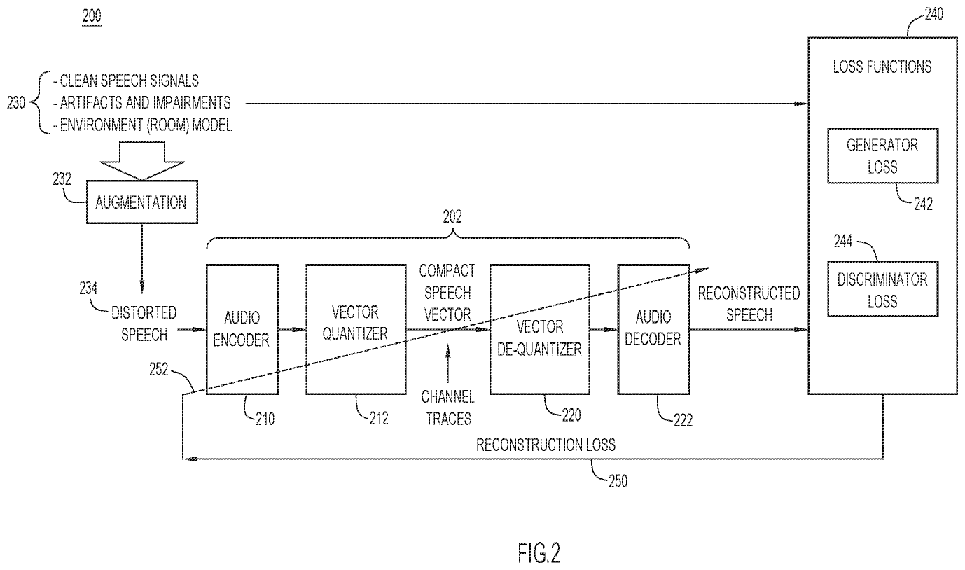

Reference is now made to FIG. 2. FIG. 2 shows an arrangement 200 by which components of a neural audio codec system 202 are trained end-to-end using thousands of hours of speech and artifacts and impairments. Similar to FIG. 1, the neural audio codec system 202 includes an audio encoder 210, vector quantizer 212, vector de-quantizer 220 and audio decoder 222, and each of these components may use a neural network model (or more generally machine learning-based model) for their operations.

To train the neural audio codec system 202, as shown at reference numeral 230 various artifacts and impairments are applied to the clean speech signals through an augmentation operation 232 to produce distorted speech 234. The artifacts and impairments may include background noise, reverberation, band limitation, packet loss, etc. In addition, an environment model, such as a room model, may be used to impact the clean speech signals. The distorted speech 234 is then input into the codec system 202.

The training process involves applying loss functions 240 to the reconstructed speech that is output by the audio decoder 222. The loss functions 240 may include a generative loss function 242 and an adversarial/discriminator loss function 244. The loss functions 240 output a reconstruction 250 that is used to adjust parameters of the neural network models used by the audio encoder 210, vector quantizer 212, vector de-quantizer 220 and audio decoder 222, as shown at 252. Thus, the neural network models used by the audio encoder 210, vector quantizer 212, vector de-quantizer 220 and audio decoder 222 may be trained in an end-to-end hybrid manner using a mix of reconstruction and adversarial losses.

As a result of this training, the audio encoder 210 takes raw audio input and leverages a deep neural network to extract a comprehensive set of features that encapsulate intricate speech and background noise characteristics jointly or separately. The extracted speech features represent both the speech semantic as well as speech stationary attributes such as volume, pitch modulation, accent nuances, and more. This represents a departure from conventional audio codecs that rely on manually designed features, whereas in the embodiments presented herein, the neural audio codec systems learns and refines its feature extraction process from extensive and diverse datasets, resulting in a more versatile and generalized representation.

The output of the audio encoder 210 materializes as an embedding vector, with each vector encapsulating a snapshot of audio attributes over a timeframe. The vector quantizer 212 further compresses the embedding vector into a compact speech vector, i.e., codewords, using a residual vector quantization (RVQ) model. Vector quantizer 212 may also be implanted using product vector quantization, also known as group vector quantization. Such an approach employs multiple layers, but unlike RVQ, each layer works in parallel. The embodiments described herein are not limited to any particular quantizer implementation. The codeword indices streams are ready for transmission or storage. At the receiving end, the audio decoder takes the compressed bitstream as input, reverses the quantization process, reconstructs the speech into time-domain waveforms.

The end-to-end training may result in a comprehensive and compact representation of clean speech. This is a data-driven compressed representation of speech, where the representation has a lower dimensionality that makes it easier to manipulate and utilize than if the speech were in its native domain. By “data-driven” it is meant that the representation of speech is developed or derived through ML-based training using real speech data, rather than a human conjuring the attributes for the representation. The data used to train the models may include a wide variety of samples of speech, languages, accents, different speakers, etc.

In the use case of speech enhancement, the compact speech vector represents “everything” needed to recover speech but discarding anything else related to artifacts or impairments. Thus, for speech enhancement applications, the neural audio codec system does not encode audio, but rather, encodes only speech, discarding the non-speech elements. In so doing, the neural audio codec system can achieve a more uniquely speech-related encoding, and that encoding is more compact because it does not express the other aspects that are included in the input audio. Training to encode speech is effectively training to reject everything else, and this can result in a stronger speech encoded foundation for any other transformation to or from speech.

### Loss Functions Useful During Training

Reconstruction losses may be used to minimize the error between the clean signal, known as a target signal, x and an enhanced signal generated by the neural audio codec, denoted \hat{x}, which is denoised and dereverberated and/or with concealed packets/frames loss of its input signal y, noisy, reverberated audio signal and/or with lost packets/frames. One or more reconstruction losses may be used in the time domain or time-frequency domain.

A loss in the time domain may involve minimizing a distance between estimated clean \hat{x} and the target signal x time domain:

$${ℒ}_{𝔱} = {\sum }_{n = 1}^{N} \vert x [ n ] - \hat{x} [ n ] \vert ,$$

where [symbol] ₜ is the L1 norm loss and N denotes to number of samples of \hat{x} and x in the time domain, where L1 Norm is a sum of the magnitudes of the vectors in a space and is one way to measure distance between vectors (sum of absolute difference of components of the vectors). In some implementations, the L1 norm loss and/or the L2 norm loss may be used.

A weighted signal-to-distortion radio (weighted SDR) may be used, where the input signal y is represented as x with additive noise n: y=x+n, then SDR loss is defined as:

$${ℒ}_{SDR} ( x , \hat{x} ) = - \frac{〈 x , \hat{x} 〉}{‖ x ‖ ‖ \hat{x} ‖} ,$$

where the operator [symbol] , [symbol] represents the inner product and ∥, ∥ represents Euclidean norm. This loss is phase sensitive with the range [−1,1]. For noise only samples, to be more precise, a noise prediction term is added to define the final weighted SDR loss:

$${ℒ}_{SDR} ( x , n , \hat{n} ) = {ℒ}_{SDR} ( x , \hat{x} ) + {ℒ}_{SDR} ( n , \hat{n} ) ,$$

where \hat{n}=y−\hat{x} is estimated noise.

Multi-scale Short-Time Fourier Transform (MS STFT) operates in the frequency domain using different window lengths. This approach of using various window lengths is inspired by the Heisenberg Uncertainty Principle, which shows that a larger window length gives greater frequency resolution but lower time resolution, and the opposite for a shorter window length. Therefore, the MS STFT uses a range of window lengths to capture different features of the audio waveform.

### The Loss is Defined as:

$${ℒ}_{MSTFT} = {\sum }_{l = 1}^{L} {\sum }_{k = 1}^{K} \vert {S}^{w} [ l , k ] - {\hat{S}}^{w} [ l , k ] \vert + {α}_{w} {\sum }_{l = 1}^{L} {\sum }_{k = 1}^{K} \sqrt{{\vert log ( {S}^{w} [ l , k ] ) - log ( {\hat{S}}^{w} [ l , k ] ) \vert}^{2}} ,$$

where S^{w}[l, k] is the energy of the spectrogram at frame l and frequency bin k and characterized by a window w, K is the number of frequency bins, L is the number of frames and a_{w} is a parameter to balance between L1 Norm and L2 Norm part of the loss, where the L2 Norm is the square root of the sum of the entries of a vector. The second part of the loss is computed using a log operator to compress the values. Generally, most of the energy content of speech signal is concentrated below 4 kHz. Therefore, the energy magnitude in lower frequency components is significantly higher than higher frequency components, with going to log domain, the magnitude of higher frequencies and lower frequencies get closer, thus more focus on higher frequency components compared to linear scale. A high-pass filter can be designed to improve performance for high-frequency content.

A Mean Power Spectrum (MPS) loss function aims to minimize the discrepancy between the mean power spectra of enhanced and clean audio signals in the logarithmic domain using L2 Norm.

### The Power Spectrum of the Signal is Computed as Below:

$$P ( x ) = 1 / N {\sum }_{n = 0}^{N - 1} {\vert {X}_{n} \vert}^{2} ,$$

where P(x) is the mean power spectrum of signal x, X is FFT/STFT of signal x.

A logarithm may be applied to the mean power spectrum (MPS), such that the logarithmic power spectrum of a signal x is:

$$L ( x ) = 10 {log}_{10} ( P ( x ) + ϵ ) ,$$

where ϵ is a small constant to prevent the logarithm of zero.

The MPS loss between the enhanced and clean signals can then be defined as the L2 Norm of the difference between their logarithmic power spectra:

$${ℒ}_{MPS} ( \hat{x} , x ) = \sqrt{\sum {( L ( \hat{x} ) - L ( x ) )}^{2}} .$$

Generative Adversarial Networks (GANs) comprise two main models: generator and discriminator. In the neural network codec system, the audio encoder, vector quantizer and audio decoder may employ GAN generator and discriminator models. As an example, two adversarial loss functions could be used in the neural audio codec system: Lease-squared adversarial loss functions and hinge loss functions.

Least square (LS) loss functions for discriminator and generator may be respectively defined as:

$${ℒ}_{ADV} ( D ; G ) = {E}_{( x , s )} [ {( D ( x ) - 1 )}^{2} + {D ( G ( y ) )}^{2} ] , {ℒ}_{ADV} ( G ; D ) = {E}_{d} [ {D ( G ( y ) - 1 )}^{2} ] ,$$

For discriminator loss, [symbol] _{ADV} (D; G), E_{(,)} is the expectation operator, D(x), is the output of the discriminator for a real signal x, D(G(y)) is the discriminator output of enhanced (fake) signal and [symbol] _{ADV} (G; D) is the generator loss.

Hinge loss for the discriminator and generator may be defined as:

$${ℒ}_{ADV} ( D ; G ) = {E}_{( x , y )} [ max ( 1 - D ( x ) , 0 ) + max ( 0 , 1 + D ( G ( y ) ) ) ] , {ℒ}_{ADV} ( G ; D ) = {E}_{y} [ max ( 1 - D ( G ( y ) ) , 0 ) ] ,$$

Hinge loss may be preferred over least square loss because in the case of discriminator loss, hinge loss tries to maximize the distance between the real signal and fake signal while LS loss tries to score 1 when the input is a “real signal” and 0 when the input is “fake signal”.

In addition to above-mentioned losses, feature matching may be used to minimize the difference between the intermediate features of each layer of real and generated signals when passed through the discriminator. Instead of solely relying on the final output of the discriminator, feature matching ensures that the generated samples have similar feature statistics to real samples at various levels of abstraction. This helps in stabilizing the training process of adversarial networks by providing smoother gradients. Feature matching loss may be defined as:

$${ℒ}_{FM} ( G ; D ) = {E}_{( x , y )} [ {\sum }_{i = 1}^{T} \frac{1}{{N}_{i}} {‖ {D}^{i} ( x ) - {D}^{i} ( G ( y ) ) ‖}_{1} ] ,$$

where Nᵢ is the number of layers in the discriminator D, and superscript i is used to design the layer number. Note that feature matching loss updates only generator parameters.

Several different discriminator models may be suitable for use in the training arrangement of FIG. 2, including: Multi-Scale Discriminator (MSD), Multi-Period Discriminator (MPD) and Multi-Scale Short-Time Fourier Transform (MS-STFT).

For a MSD, the discriminator is looking at the waveform at the different sampling rates. The waveform discriminators have the same network architecture but use different weights. Each network is composed of n number of strided 1-dimensional (1D) convolution blocks, an additional 1D convolution, and global average pooling to output a real-value score. A “leaky” rectifier linear unit (Leaky ReLu) may be used between the layers for the purpose of non-linearity of the network.

A MPD operates on the time-domain waveform and tries to capture implicit periodicity structure of the waveform. In an MPD discriminator, different periods of the waveform are considered. For each period, the same network architecture, with different weights, are used. The network consists of n strided two-dimensional (2D) convolution blocks, an additional convolution, and a global average pooling for outputting a scalar score. In the convolution block weight normalization may be used along with a Leaky ReLu as an activation function.

An MS-STFT discriminator, unlike the MSD and MPD, operates in the frequency domain using a Short-Time Fourier Transform (STFT). This discriminator enables the model to analyse the spectral content of the signal. The MS-STFT discriminator analyzes the “realness” of the signal at multiple time-frequency scales or resolutions. Having spectral content of the waveform in various resolutions, the model is able to analyze the “realness” of the waveform more profoundly. The MS-STFT discriminator may be composed of t equivalent networks that handle multi-scaled complex-valued STFTs with incremental window lengths and corresponding hop sizes. Each of these networks contains a 2D convolutional layer, with weight normalization applied, featuring a n×m kernel size and c number of channels, followed by a Leaky ReLu non-linear activation function. Subsequent 2D convolution layers have dilation rates in the temporal dimension and an output stride of j across the frequency axis. At the end we have d×d convolution with stride 1 followed by flatten layer to get the output scores.

Finally, the total loss of adversarial training may be defined as:

$$ℒ = {λ}_{FM} {ℒ}_{FM} + {λ}_{MSTFT} {ℒ}_{MSTFT} + {λ}_{G} {ℒ}_{ADV} ( G ; D ) + {λ}_{D} {ℒ}_{A D V} ( D ; G ) + {λ}_{𝔱} {ℒ}_{𝔱} + {λ}_{SDR} {ℒ}_{SDR} + {λ}_{MPS} {ℒ}_{MPS} ,$$

where λ coefficients are used to give more weights to some losses compared to the other losses, [symbol] _{FM} is the feature matching loss. [symbol] _{MSTFT} is MS-STFT loss that can be replaced by [symbol] _{MSD} for MSD discriminator or [symbol] _{MPD} for MPD discriminator.

Any one or more of the loss functions referred to above, or other loss functions now known or hereinafter developed, may be used in the training process depicted in FIG. 2. The architecture of the end-to-end training, from the encoder side to the decoder side, produces the embedding vectors that can be exploited for a variety of applications as described below. The training results in an embedding vector representation that lends itself to convergence, accuracy, etc. Again, this is a result of the characteristics that are trained for, selection of loss functions, training content, selection criteria for epics, etc., to arrive at the embedding vectors that have desirable characteristics of: rejecting non-speech (for speech enhancement applications), easy to encode speech, and durability across speech applications.

### Packet Loss Concealment

Packet loss during audio communication can substantially degrade the overall listening experience by introducing disruptions and distortions. Embodiments described herein effectively address packet loss by using a blend of technical remedies and adept network management practices aimed at upholding a steady and topnotch audio stream.

As noted previously, recently, the utilization of large language models, often referred to as LLMs, has demonstrated tremendous potential in tasks such as summarization, translation, prediction, and text generation. These capabilities are derived from the vast knowledge these models have acquired through extensive training on massive datasets. However, the inherent complexity of LLMs can render their integration into real-time communication systems impractical.

Described below is the use of a “nano” language model (“nano LM”) Predictor, combined with the neural audio codec system 100, for packet loss concealment (PLC). The PLC approach employs an AI model to predict missing packets in the quantized domain, also known as codewords or codeword indices. Specifically, the nano LM may be integrated into the neural audio codec system 100 and may be configured to predict lost codeword indices of quantized vector (VQ) blocks using a language modelling approach.

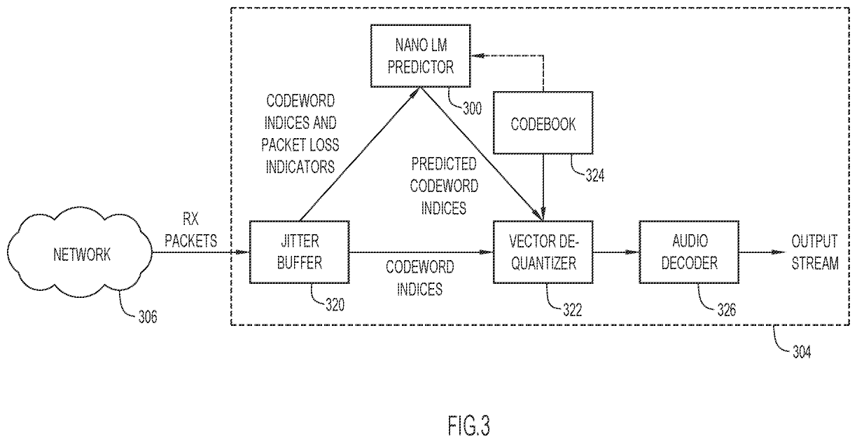

FIG. 3 depicts a block diagram of the receive side of the neural audio codec system 100 including a nano LM Predictor 300 configured for packet loss concealment according to an example embodiment. As shown, and similarly to what is shown in FIG. 1, the receive side 304 obtains received (RX) packets from the network 306. At the receive side 304, there are a jitter buffer 320, vector de-quantizer 322, codebook 324 and an audio decoder 326. The jitter buffer 320 keeps track of the incoming packets, putting them in order and deciding when to process and play a packet. The jitter buffer 320 may also be used to detect packet loss. The vector de-quantizer 322 de-quantizes received codeword indices and using the codebook 324, outputs recovered embedding vectors. The audio decoder 326 decodes the embedding vectors to produce an output audio stream.

As further illustrated, the nano LM Predictor 300 has access to the history of arriving codeword indices, and optionally to the codebooks of the VQ. Using this information, the nano LM Predictor 300 is configured to predict the next codeword indices when there is packet loss as reported by jitter buffer 320, where a given packet may contain a plurality of indices.

When packet at frame t is lost, and reported or indicated by jitter buffer 320, the nano LM Predictor 300 predicts the missing codeword, denoted as cₜ, by maximizing the probability of cₜ being in the codebook [symbol] based on the codewords received from frames t−1, t−2, . . . , t−L. It can be further simplified as predicting the missing codeword index at frame t, denoted as Iₜ, upon receiving the codeword indices in the past L frames shown eq. (1):

$${I}_{t} = {arg max}_{i = 1 , 2 , … , \vert ℂ \vert} p ( i \vert \{ {I}_{t - 1} , {I}_{t - 2} , … , {I}_{t - L} \} ) , \qquad ( 1 )$$

Here, | [symbol] | represents the number of codewords in the codebook [symbol] , and p is the probability of selecting the i^{th} codeword. By transitioning PLC from the waveform domain to the codeword indices domain, the nano LM Predictor 300 effectively reduces the problem from an infinite domain to a finite and more manageable one.

As depicted in FIG. 3, the nano LM Predictor 300 has access to the history of previously selected codeword indices and optionally also to the codebook of the VQ layers. When there is a packet loss, the jitter buffer 320 requests the nano LM Predictor 300 to predict the lost codeword indices, and the predicted ones are used by the rest of the system to generate the audio. The history of selected codeword indices that the nano LM Predictor 300 utilizes in making predictions might contain both the successfully arriving codeword indices and the previous predictions (“previously-predicted indices of codewords”) of the nano LM Predictor 300 in case of packet losses. In the second case, the nano LM Predictor 300 works in a recursive mode conditioning on its previous predictions for the next ones.

The nano LM Predictor 300 may be built by any sequence modelling neural layers, such as convolutional, recurrent, attentional, normalization and nonlinearity layers. It takes a sequence of indices as input and generates a sequence of codeword indices for each frame. To process the input codeword indices which are integers between 0 to | [symbol] |−1, where | [symbol] | is the codebook size, with the subsequent neural layers, nano LM Predictor 300 first converts the indices into high dimensional vectors with a trainable look-up table which may be referred to as an Embedding layer. Nano LM Predictor 300 could utilize VQ codebook as its embedding layers, or it could have its own trainable embedding layers.

To solve equation (1), one might initially contemplate a brute force approach. However, this becomes impractical due to the problem's (non-deterministic polynomial-time) NP-hard complexity. Leveraging the capabilities of neural networks and machine learning, the nano LM Predictor 300 can efficiently address the issue, even when attempting to leverage extensive historical data, denoted as a large L. For example, to recover a loss occurring between 100 milliseconds and 150 milliseconds, the system may be configured to construct a model capable of analyzing a time window from 300 milliseconds to 450 milliseconds. Given a frame size of 10 milliseconds, this would necessitate a history size (L) ranging from 30 to 45 frames.

When training the neural audio codec system 100 to obtain a trained or previously-trained machine learning process or engine, the system might use some end-to-end losses that evaluate the output audio of the neural audio codec system 100 based on some goodness-of-fit criteria, and backpropagate the gradient of that loss to all the blocks, including the audio decoder 326, the nano LM Predictor 300, vector quantizer 112/vector de-quantizer 122, 322 and the audio encoder 110. Reconstruction losses compare the output audio with the reference audio either in waveform, frequency, or some other domain and computes a loss based on pairwise differences. Adversarial losses use a discriminator network to differentiate between reference audios that did not pass through the neural audio codec system 100, and the audio that are output of the neural audio codec system 100. The neural audio codec system 100 plays an adversarial game with the discriminator, trying to generate an audio in such quality that the discriminator network cannot distinguish it from reference audios.

Aside from end-to-end losses, the system might also use loss functions per block just evaluating the performance of that block based on some goodness-of-fit criteria. As an example, the system can use a distance-based loss for the vector quantizer alone penalizing the quantization errors between VQ input and de-quantizer output.

The nano LM Predictor 300 may be trained both with end-to-end losses, or loss functions just evaluating its performance in predicting the lost codeword indices. Similarly, the nano LM Predictor 300 may be trained from scratch together with all the other blocks of the neural audio codec system 100. Alternatively, one might first train the neural audio codec system 100 without the nano LM Predictor 300 and without the PLC task using no lost packets in training. Once the neural audio codec system 100 is trained to generate a good quality audio output, the other blocks can be frozen and the nano LM Predictor 300 may be introduced and trained with a diverse set of packet loss and audio sequences.

There are various end-to-end losses that could be used to train the nano LM Predictor 300 as well as all the other blocks of the neural audio codec system 100, such as distance-based losses in waveform domain, multi-scale short time Fourier transform losses in frequency domain, and adversarial losses such using audio or frequency domain discriminator networks such as MSD, MPD, etc.

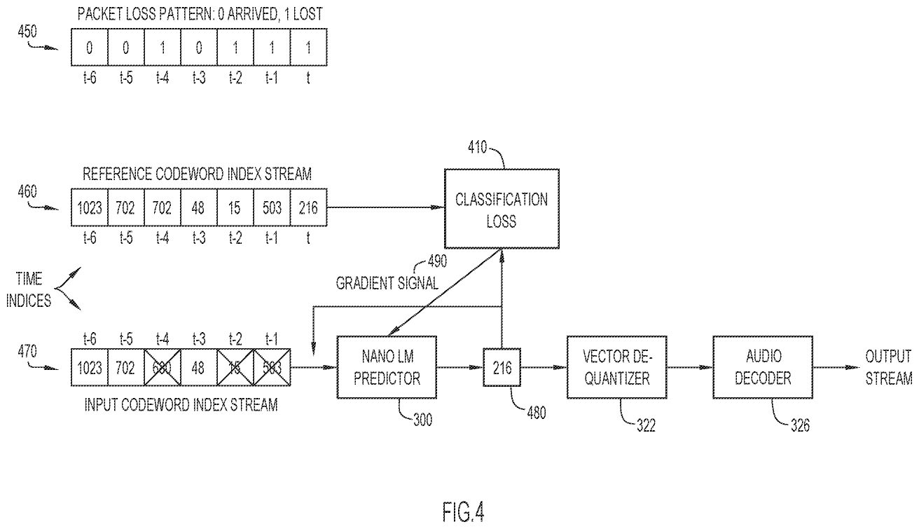

When it comes to train the nano LM Predictor 300 with loss functions defined on its own performance alone, one can define the problem as a classification task, and use classification losses such as cross entropy. For example, if there are 1024 codewords in a layer of VQ, the nano LM Predictor 300 will be predicting the indices of these codewords in the codebook, so the problem can be thought of as if doing a classification among 1024 classes. This is shown in FIG. 4, which illustrates one approach for training the nano LM Predictor 300 with classification loss 410 according to example embodiment. That is, the nano LM Predictor 300 takes the codeword indices history 460 as input (and given an altered version thereof in accordance with packet loss pattern 450, i.e., input codeword index stream 470) predicts the indices 480 for the next time step, based on gradient signal 490. In case of a packet loss, the output of the nano LM Predictor 300 is used by the rest of the neural audio codec system 100 to generate audio. The history the nano LM Predictor 300 uses includes successfully arrived indices as well as previous predictions for the lost packets. Such predictions might be erroneous.

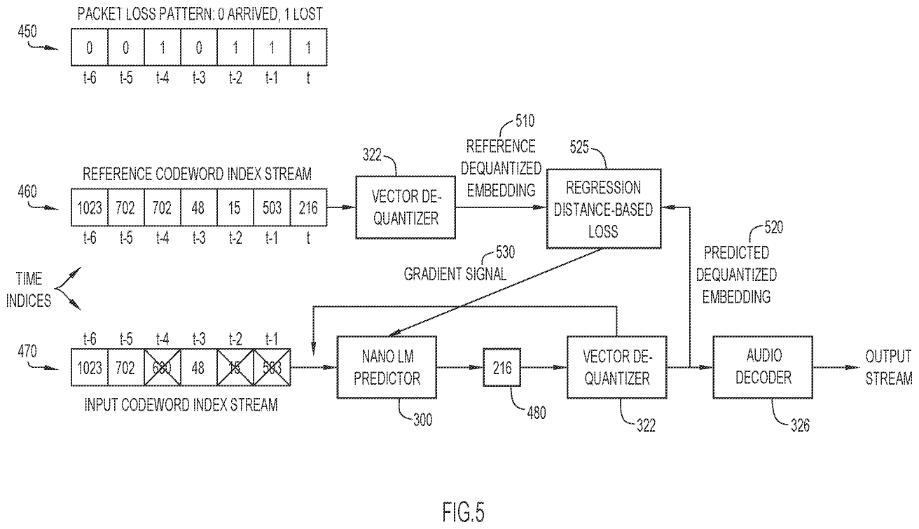

Alternatively, after predicting the next index with the nano LM Predictor 300, the system may be configured to dequantize the index with vector de-quantizer 322, and thereafter obtain the predicted dequantized vector, as shown in FIG. 5. That is, the actual dequantized embedding 510 for the reference data may be supplied to a module to perform regression distance-based loss 525 using a distance function comparing the two dequantized vectors: the actual one (i.e., the reference dequantized embedding 510) and the predicted dequantized embedding 520. A resulting gradient signal 530 may be supplied back to nano LM Predictor 300.

The neural audio codec system 100 may use multi-layer vector quantization methods such as Residual Vector Quantization (also known as multi-stage vector quantization) and Product Quantization (also known as group quantization) for efficiently scaling to high bitrates. In product quantization, the input embedding is split into groups and each group is quantized separately in parallel. In case product quantization is used in the system, a separate nano LM predictor may be trained for each one of the groups as they work independently from the others. On the other hand, each layer of the Residual VQ takes the residual signal from the layers below and quantizes it to further reduce the quantization error. In this case, the layers work in series and each layer depends on the selections made in the layers lower in the hierarchy. If Residual VQ is employed in the neural audio codec system 100, the nano LM Predictor for each of the layers could also condition on the predictions of the nano LM Predictors of the previous layers in addition to conditioning on the history in the current layer. Such conditioning could be performed in a number of ways. For example, the system can generate a conditioning input vector for the lower layer predictions by:
converting the predicted codeword indices in the previous layers into an embedding using the Residual VQ dequantization; and/or
converting the predicted codeword indices into a binary representation.

The conditioning input vector may be utilized in a number of ways by the nano LM Predictor 300. For example, the nano LM Predictor 300 may concatenate the conditioning vector to the input of the current layer, or may use it to transform the input, intermediate layer outputs, or the final output.

In another variant of nano LM Predictor for multiple layer VQ codebooks, a single nano LM Predictor could generate the predictions for all layers at once. In such a case, the nano LM predictor might have multiple output layers, one for each layer, and it could utilize the VQ layer index while generating the predictions for that layer.

Thus, those skilled in the art will appreciate that among the advantages of the approach described herein is its affordability and resource efficiency. Unlike complex and resource-intensive solutions, the described methodologies harness the power of the nano LM Predictor 300 to handle packet loss. This not only ensures high-quality audio transmission but also makes it accessible for a wide range of applications where computational limitations and cost considerations are paramount.

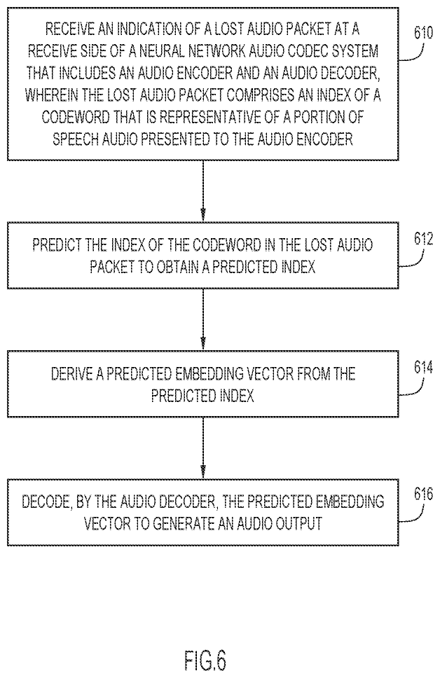

FIG. 6 is a flowchart illustrating a series of operations to perform packet loss concealment using the nano LM Predictor 300 according to an example embodiment. At 610, an operation is configured to receive an indication of a lost audio packet at a receive side of a neural network audio codec system that includes an audio encoder and an audio decoder, wherein the lost audio packet comprises an index of a codeword that is representative of a portion of speech audio presented to the audio encoder. At 612, an operation is configured to predict the index of the codeword in the lost packet to obtain a predicted index. At 614, an operation is configured to derive a predicted embedding vector from the predicted index. And, at 616, an operation is configured to decode, by the audio decoder, the embedding vector to generate an audio output.

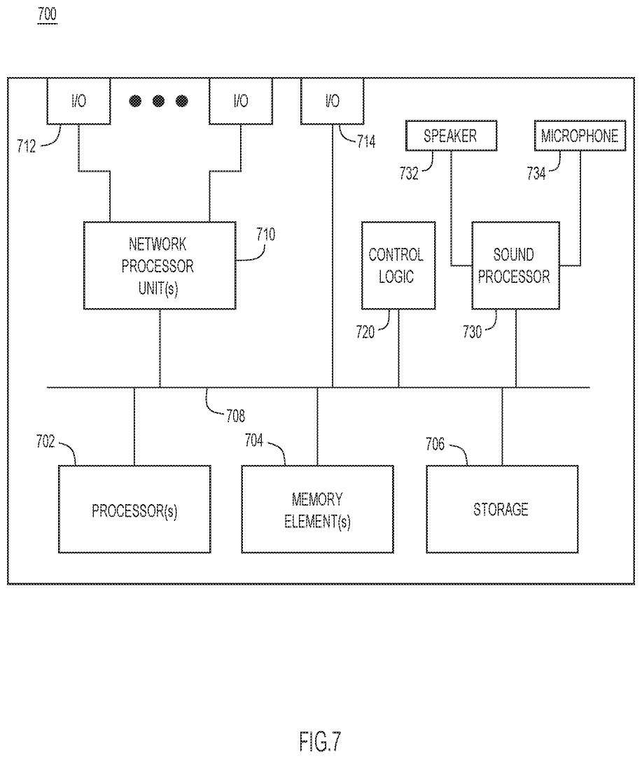

FIG. 7 is a hardware block diagram of a networking/computing device/apparatus/appliance/endpoint that may perform functions associated with any combination of operations in connection with the techniques depicted in FIGS. 1-6 described herein. It should be appreciated that FIG. 7 provides only an illustration of one example embodiment and does not imply any limitations with regard to the environments in which different example embodiments may be implemented. Many modifications to the depicted environment may be made.

In at least one embodiment, the computing device 700 may be any apparatus that may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for device 700 as described herein according to software and/or instructions configured for device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 704 and/or storage 706 is/are configured to store data, information, software, and/or instructions associated with device 700, and/or logic configured for memory element(s) 704 and/or storage 706. For example, any logic described herein (e.g., control logic 720) can, in various embodiments, be stored for device 700 using any combination of memory element(s) 704 and/or storage 706. Note that in some embodiments, storage 706 can be consolidated with one or more memory elements 704 (or vice versa), or can overlap/exist in any other suitable manner. In one or more example embodiments, process data is also stored in the one or more memory elements 704 for later evaluation and/or process optimization.

In at least one embodiment, bus 708 can be configured as an interface that enables one or more elements of device 700 to communicate in order to exchange information and/or data. Bus 708 can be implemented with any architecture designed for passing control, data and/or information between processors, memory elements/storage, peripheral devices, and/or any other hardware and/or software components that may be configured for device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to device 700. For example, I/O interface(s) 714 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards.

In various embodiments, control logic 720 can include instructions that, when executed, cause processor(s) 02 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In the even the device 700 is an endpoint (such as telephone, mobile phone, desk phone, conference endpoint, etc.), then the device 700 may further include a sound processor 730, a speaker 732 that plays out audio and a microphone 734 that detects audio. The sound processor 730 may be a sound accelerator card or other similar audio processor that may be based on one or more ASICs and associated digital-to-analog and analog-to-digital circuitry to convert signals between the analog domain and digital domain. In some forms, the sound processor 730 may include one or more digital signal processors (DSPs) and be configured to perform some or all of the operations of the techniques presented herein.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 706 and/or memory elements(s) 704 can store data, software, code, instructions (e.g., processor instructions), logic, parameters, combinations thereof, and/or the like used for operations described herein. This includes the storage 706 and/or memory elements(s) 704 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, load balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method including: receiving an indication of a lost audio packet at a receive side of a neural network audio codec system that includes an audio encoder and an audio decoder, wherein the lost audio packet includes an index of a codeword that is representative of a portion of speech audio presented to the audio encoder; predicting the index of the codeword in the lost audio packet to obtain a predicted index; deriving a predicted embedding vector from the predicted index; and decoding, by the audio decoder, the predicted embedding vector to generate an audio output.

In some aspects, the techniques described herein relate to a method, wherein predicting the index of the codeword of the lost audio packet is based on a history of previously received indices of codewords.

In some aspects, the techniques described herein relate to a method, further including predicting the index of the codeword of the lost audio packet by maximizing a probability, in a previously-trained machine learning process, that the predicted index is a likely next index given the history of previously received indices of codewords.

In some aspects, the techniques described herein relate to a method, wherein the previously-trained machine learning process was trained based on classification losses.

In some aspects, the techniques described herein relate to a method, wherein the classification losses include cross entropy evaluation.

In some aspects, the techniques described herein relate to a method, wherein the previously-trained machine learning process was trained by de-quantizing the predicted index to obtain the predicted embedding vector and applying a regression distance-based loss function based on the predicted embedding vector and a reference embedding vector.

In some aspects, the techniques described herein relate to a method, wherein the previously-trained machine learning process is a language model that is trained to predict codeword indices to codewords in a codebook.

In some aspects, the techniques described herein relate to a method, wherein predicting the index of the codeword of the lost audio packet is based on previously-predicted indices of codewords.

In some aspects, the techniques described herein relate to a method, further including predicting the index of the codeword of the lost audio packet in a recursive manner, including conditioning on the previously-predicted indices of codewords.

In some aspects, the techniques described herein relate to a method including: receiving a sequence of audio packets representing speech audio, each audio packet including an index of a codeword that is representative of a portion of the speech audio; predicting an index of a codeword for a current audio packet based on one or more previous audio packets in the sequence of audio packets to obtain a predicted index; deriving a predicted embedding vector from the predicted index; and decoding the predicted embedding vector to generate audio output.

In some aspects, the techniques described herein relate to a method, further including predicting the index of the codeword by maximizing a probability, in a previously-trained machine learning process, that a predicted index of the codeword is a likely next index given the sequence of audio packets and corresponding indices of codewords.

In some aspects, the techniques described herein relate to a method, wherein the previously-trained machine learning process was trained based on classification losses.

In some aspects, the techniques described herein relate to a method, wherein the classification losses include cross entropy evaluation.

In some aspects, the techniques described herein relate to a method, wherein the previously-trained machine learning process was trained by de-quantizing the predicted index of the codeword to obtain a predicted embedding vector and applying a regression distance-based loss function based on the predicted embedding vector and a reference embedding vector.

In some aspects, the techniques described herein relate to a method, wherein the previously-trained machine learning process is a language model that is trained to predict codeword indices to codewords in a codebook.

In some aspects, the techniques described herein relate to a method, wherein predicting the index of the codeword is based on previously-predicted indices of codewords.

In some aspects, the techniques described herein relate to a method, further including predicting the index of the codeword in a recursive manner, including conditioning on the previously-predicted indices of codewords.

In some aspects, the techniques described herein relate to a device including: an interface configured to enable network communications; a memory; and one or more processors coupled to the interface and the memory, and configured to: receive a sequence of audio packets representing speech audio, each audio packet including an index of a codeword that is representative of a portion of the speech audio; predict an index of a codeword for a current audio packet based on one or more previous audio packets in the sequence of audio packets to obtain a predicted index; derive a predicted embedding vector from the predicted index; and decode the predicted embedding vector to generate audio output.

In some aspects, the techniques described herein relate to a device, wherein the one or more processors are further configured to predict the index of the codeword by maximizing a probability, in a previously-trained machine learning process, that a predicted index of the codeword is a likely next index given the sequence of audio packets and corresponding indices of codewords.

In some aspects, the techniques described herein relate to a device, wherein the previously-trained machine learning process was trained based on classification losses.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
receiving an indication of a lost audio packet at a receive side of a neural network audio codec system that includes an audio encoder and an audio decoder, wherein the lost audio packet comprises an index of a codeword that is representative of a portion of speech audio presented to the audio encoder;
predicting the index of the codeword in the lost audio packet to obtain a predicted index;
deriving a predicted embedding vector from the predicted index; and
decoding, by the audio decoder, the predicted embedding vector to generate an audio output.

2. The method of claim 1, wherein predicting the index of the codeword of the lost audio packet is based on a history of previously received indices of codewords.

3. The method of claim 2, further comprising predicting the index of the codeword of the lost audio packet by maximizing a probability, in a previously-trained machine learning process, that the predicted index is a likely next index given the history of previously received indices of codewords.

4. The method of claim 3, wherein the previously-trained machine learning process was trained based on classification losses.

5. The method of claim 4, wherein the classification losses comprise cross entropy evaluation.

6. The method of claim 3, wherein the previously-trained machine learning process was trained by de-quantizing the predicted index to obtain the predicted embedding vector and applying a regression distance-based loss function based on the predicted embedding vector and a reference embedding vector.

7. The method of claim 3, wherein the previously-trained machine learning process is a language model that is trained to predict codeword indices to codewords in a codebook.

8. The method of claim 1, wherein predicting the index of the codeword of the lost audio packet is based on previously-predicted indices of codewords.

9. The method of claim 8, further comprising predicting the index of the codeword of the lost audio packet in a recursive manner, including conditioning on the previously-predicted indices of codewords.

10. A method comprising:
receiving a sequence of audio packets representing speech audio, each audio packet including an index of a codeword that is representative of a portion of the speech audio;
predicting an index of a codeword for a current audio packet based on one or more previous audio packets in the sequence of audio packets to obtain a predicted index;
deriving a predicted embedding vector from the predicted index; and
decoding the predicted embedding vector to generate audio output.

11. The method of claim 10, further comprising predicting the index of the codeword by maximizing a probability, in a previously-trained machine learning process, that a predicted index of the codeword is a likely next index given the sequence of audio packets and corresponding indices of codewords.

12. The method of claim 11, wherein the previously-trained machine learning process was trained based on classification losses.

13. The method of claim 12, wherein the classification losses comprise cross entropy evaluation.

14. The method of claim 11, wherein the previously-trained machine learning process was trained by de-quantizing the predicted index of the codeword to obtain a predicted embedding vector and applying a regression distance-based loss function based on the predicted embedding vector and a reference embedding vector.

15. The method of claim 11, wherein the previously-trained machine learning process is a language model that is trained to predict codeword indices to codewords in a codebook.

16. The method of claim 10, wherein predicting the index of the codeword is based on previously-predicted indices of codewords.

17. The method of claim 16, further comprising predicting the index of the codeword in a recursive manner, including conditioning on the previously-predicted indices of codewords.

18. A device comprising:
an interface configured to enable network communications;
a memory; and
one or more processors coupled to the interface and the memory, and configured to:
receive a sequence of audio packets representing speech audio, each audio packet including an index of a codeword that is representative of a portion of the speech audio;
predict an index of a codeword for a current audio packet based on one or more previous audio packets in the sequence of audio packets to obtain a predicted index;
derive a predicted embedding vector from the predicted index; and
decode the predicted embedding vector to generate audio output.

19. The device of claim 18, wherein the one or more processors are further configured to predict the index of the codeword by maximizing a probability, in a previously-trained machine learning process, that a predicted index of the codeword is a likely next index given the sequence of audio packets and corresponding indices of codewords.

20. The device of claim 19, wherein the previously-trained machine learning process was trained based on classification losses.
